(19) United States
(12) Patent Application Publication
(10) Pub. No.: US 2023/0176385 A1
(43) Pub. Date: Jun. 8, 2023

(54) HEAD-MOUNTED DISPLAY DEVICE AND EYE DISTANCE ADJUSTMENT SYSTEM

(71) Applicant: SEIKO EPSON CORPORATION, Tokyo (JP)

(72) Inventor: Kazuya KAMAKURA, MATSUMOTO-SHI (JP)

(73) Assignee: SEIKO EPSON CORPORATION, Tokyo (JP)

(21) Appl. No.: 18/075,418

(22) Filed: Dec. 6, 2022

(30) Foreign Application Priority Data
Dec. 7, 2021 (JP) 2021-198291

(51) Int. Cl. G02B 27/01

(52) U.S. Cl. CPC G02B 27/0179; G02B 27/0172; G02B 2027/0178; G02B 2027/0181

(57) ABSTRACT

A head-mounted display device includes: a first adjustment member including a first rotating portion having a first direction as an axial direction of a rotation axis and a first extending portion extending to one side in the first direction; a second adjustment member that is configured to be fitted to the first extending portion, a first display unit fixed by the second adjustment member; and a first elastic member of which one side is in contact with the first adjustment member, of which the other side is in contact with the second adjustment member, and that is covered by the first extending portion and the second adjustment member.

The present application is based on, and claims priority from JP Application Serial Number 2021-198291, filed Dec. 7, 2021, the disclosure of which is hereby incorporated by reference herein in its entirety.

### BACKGROUND

### 1. Technical Field

The present disclosure relates to a head-mounted display device that displays an image while being worn on the user's head, and an eye distance adjustment system applicable to the head-mounted display device.

### 2. Related Art

As a personal viewer that is applicable as a head-mounted display device or the like and with which a display image can be viewed with both eyes, a device is known in which causing an adjustment screw to rotate by a knob causes a reflection mirror that reflects image light within the device to be moved, and the position of the left and right images to be adjusted (JP-A-6-242394).

However, in the display device as illustrated in JP-A-6-242394, there is slight play between the moving frame supporting the reflection mirror and the adjustment screw, and this may cause looseness (rattling) and affect image display.

### SUMMARY

A head-mounted display device according to one aspect of the present disclosure includes: a first adjustment member including a first rotating portion having a first direction as an axial direction and a first extending portion extending to one side in the first direction, a second adjustment member configured to be fitted with the first extending portion, and configured to move to the one side in the first direction when the first rotating portion rotates in a first rotational direction, and to move to the other side in the first direction when the first rotating portion rotates in a second rotational direction that is a direction opposite to the first rotational direction, a first display unit fixed by the second adjustment member, and a first elastic member having one side in contact with the first adjustment member, and another side in contact with the second adjustment member, the first elastic member being covered with the first extending portion and the second adjustment member.

### BRIEF DESCRIPTION OF THE DRAWINGS

FIG. 1 is an external perspective view explaining the worn state of a head-mounted display device according to an embodiment.

FIG. 2 is a plan view, a front view, a side view, and a bottom view of the head-mounted display device.

FIG. 3 is a plan view, a front view, a side view, and a perspective view illustrating the inside of the head-mounted display device with the outer packaging member removed.

FIG. 4 is a perspective view illustrating an external structure of an eye distance adjustment system.

FIG. 5 is a bottom view, a rear view, a plan view, a front view, and a side view of the eye distance adjustment system.

FIG. 6 is a front cross-sectional view of the eye distance adjustment system.

FIG. 7 is an exploded perspective view of the eye distance adjustment system.

FIG. 8 is a conceptual diagram for explaining the state of an extending portion and an adjustment member.

FIG. 9 is a perspective view illustrating a cover member (bushing).

FIG. 10 is a perspective view for explaining the fitting structure of the cover member (bushing) and the adjustment member (display unit attachment member).

FIG. 11 is a conceptual view for explaining the fitting structure.

FIG. 12 is a conceptual perspective view for explaining position adjustment after assembly and position adjustment at the time of assembly in the head-mounted display device.

FIG. 13 is a conceptual diagram for explaining convergence adjustment at the time of assembly.

FIG. 14 is a conceptual diagram for explaining a series of assembly operations including image height adjustment at the time of assembly.

FIG. 15 is a conceptual cross-sectional perspective view illustrating an example of a mechanism for eye width adjustment after assembly.

FIG. 16 is a conceptual side cross-sectional view explaining an internal optical system of the head-mounted display device.

### DESCRIPTION OF EXEMPLARY EMBODIMENTS

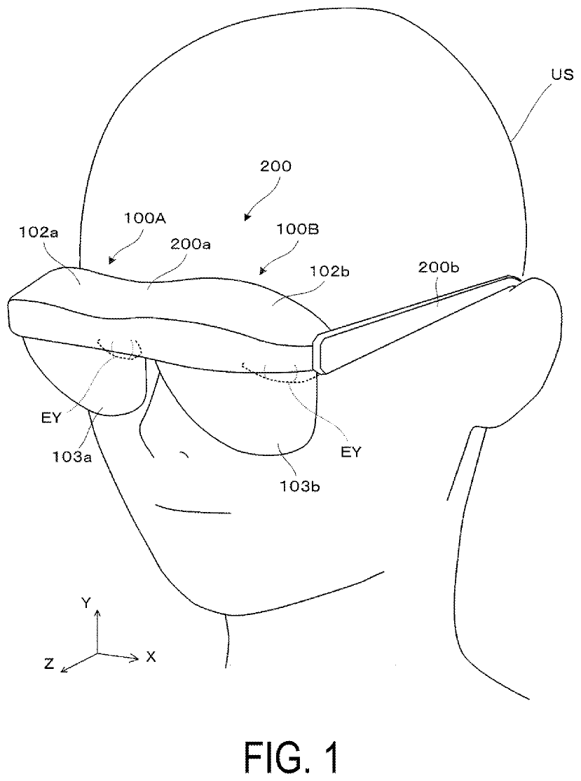

The structure, operations, and the like of an eye distance adjustment system according to an embodiment and a head-mounted display device including the eye distance adjustment system will be described below with reference to FIGS. 1 to 3 and the like.

FIG. 1 is a view explaining the worn state of a head-mounted display device 200. The head-mounted display device 200 is a head-mounted display (hereinafter also referred to as the “HMD”), and is an image display device that allows an observer or user US wearing the same to recognize an image that is a virtual image. In FIG. 1 and the like, X, Y, and Z represent an orthogonal coordinate system. The +X direction corresponds to a direction in which both eyes EY of the observer or user US wearing the head-mounted display device 200 or HMD are aligned or the lateral direction along the direction from a first display unit 100a toward a second display unit 100b to be described later. The +Y direction corresponds to an upward direction for the user US that is orthogonal to the lateral direction in which both eyes EY are aligned. The +Z direction corresponds to the forward direction or the front direction for the user US. The ±Y direction is parallel to the vertical axis or the vertical direction. In addition, of the above, the left and right X direction (±X direction) is referred to as the first direction.

The head-mounted display device 200 includes a main body 200a disposed to cover the front of the eyes of the user US, and a pair of temple-shaped support devices 200b supporting the main body 200a. Functionally speaking, the main body 200a includes a first display device 100A for the right eye and a second display device 100B for the left eye. The first display device 100A includes a display driving unit 102a disposed at an upper portion thereof, and a combiner 103a that has a spectacle lens shape and that covers the front of the eye. Similarly, the second display device 100B includes a display driving unit 102b disposed at an upper portion thereof, and a combiner 103b that has a spectacle lens shape and that covers the front of the eye.

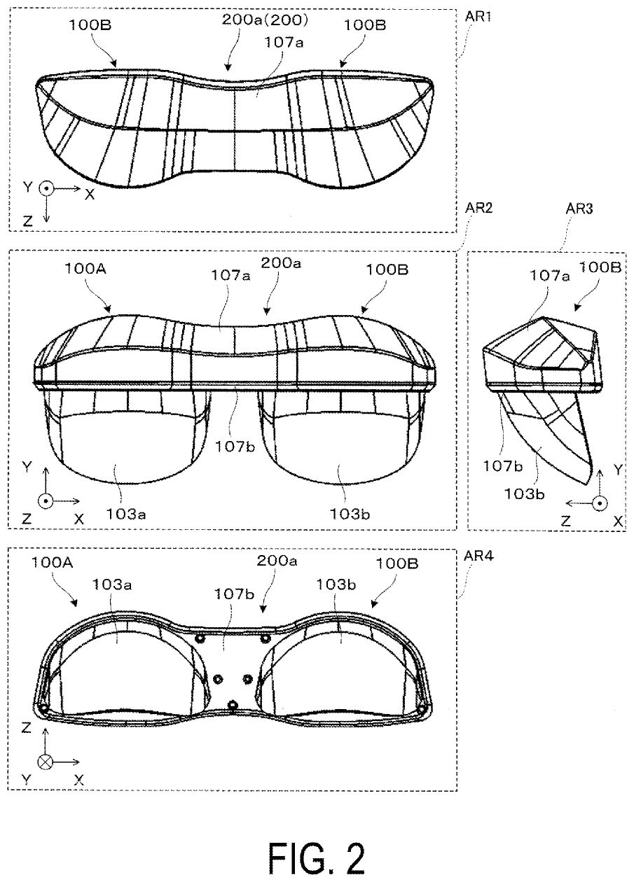

The external appearance of the main body 200a of the head-mounted display device 200 will be described with reference to FIG. 2. In FIG. 2, the state AR1 is a plan view of the main body 200a; the state AR2 is a front view of the main body 200a; the state AR3 is a side view of the main body 200a; and the state AR4 is a bottom view of the main body 200a. Of the main body 200a, a pair of display driving units 102 disposed on the +Y side, that is, on the upper side are coupled together and integrated, and are covered by a dome-shaped upper outer packaging member 107a that is elongated in the lateral direction and a flat plate-shaped lower outer packaging member 107b. The first combiner 103a and the second combiner 103b each have a shape of a hemisphere protruding frontward, that is, in the +Z direction with the upper portion thereof cut off, and are disposed so as to protrude downward from the lower outer packaging member 107b.

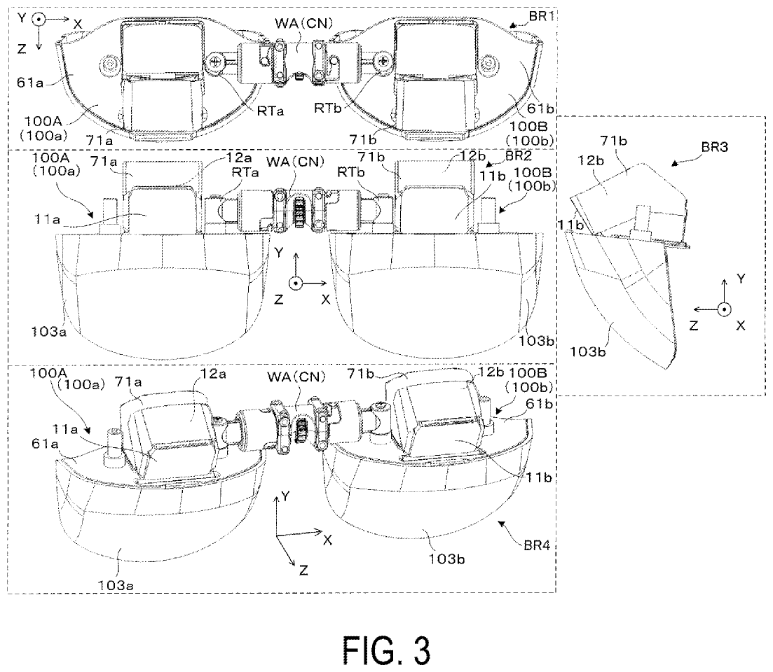

An overview of the internal structure, with the upper outer packaging member 107a and the lower outer packaging member 107b removed from the main body 200a illustrated in FIG. 2, will be described with reference to FIG. 3. In FIG. 3, the state BR1 is a plan view in which the upper portion of the main body 200a is exposed; the state BR2 is a front view in which the upper portion of the main body 200a is exposed; the state BR3 is a side view in which the upper portion of the main body 200a is exposed; and the state BR4 is a perspective view in which the internal optical system of the main body 200a is exposed. The first display device 100A for the right eye includes, as the first display unit 100a, a first display element 11a, a first optical system 12a, and a first combiner 103a. The first optical system 12a is covered by a first cover member 71a that is an inner cover and that is made of resin. The first display element 11a is disposed and fixed so as to block an opening of the first cover member 71a. Note that the first display element 11a is, for example, a self-light emission type display device, and is an image light-emitting portion including a light-emitting unit so as to generate first image light as image light. The first optical system 12a is an optical member that emits the image light (first image light) from the first display element 11a. In other words, the first display unit 100a includes the first display element 11a, and displays images by the first image light.

The first optical system 12a is fixed to the upper surface of a plate-shaped first frame 61a by bonding or the like. The first combiner 103a is fixed, at the upper end thereof, to the front half of the periphery of the first frame 61a by bonding or the like. That is, the first optical system 12a and the first combiner 103a are supported by the first frame 61a. Note that the first frame 61a is a semi-circular plate-shaped metal member, and is formed of, for example, a magnesium alloy.

The second display device 100B includes, as the second display unit 100b, a second display element 11b, a second optical system 12b, and a second combiner 103b. The second optical system 12b is covered by a second cover member 71b that is an inner cover and that is made of resin. The second display element 11b is disposed and fixed so as to block an opening of the second cover member 71b. The second display device 100B for the left eye has the same structure and function as those of the first display device 100A for the right eye. That is, the second display element 11b is similar to the first display element 11a; the second optical system 12b is similar to the first optical system 12a; and the second combiner 103b is similar to the first combiner 103a. Therefore, for example, the second display element 11b includes a light-emitting unit so as to generate second image light as image light. The second optical system 12b emits the second image light from the second display element 11b. The second display unit 100b includes the second display element 11b, and displays images by the second image light. However, in cases where the first optical system 12a, the first combiner 103a, and the like have asymmetry with respect to the left and right X direction, the second optical system 12b, the second combiner 103b, and the like are a laterally inverted version of the first optical system 12a, the first combiner 103a, and the like, respectively.

The second optical system 12b is fixed to the upper surface of a plate-shaped second frame 61b by bonding or the like. The second combiner 103b is fixed, at the upper end thereof, to the front half of the periphery of the second frame 61b by bonding or the like. That is, the second optical system 12b and the second combiner 103b are supported by the second frame 61b. Note that the second frame 61b is a semi-circular plate-shaped metal member, and is formed of, for example, a magnesium alloy.

Note that the first frame 61a is provided with a protruding portion RTa and the second frame 61b is provided with a protruding portion RTb so as to be attached to an eye distance adjustment system WA as a coupling member CN to be described later.

The first display device 100A and the second display device 100B, that is, the first display unit 100a and the second display unit 100b are internally coupled together via the eye distance adjustment system WA as the coupling member CN. The eye distance adjustment system WA is a rod-shaped metal member, and is formed of, for example, a magnesium alloy.

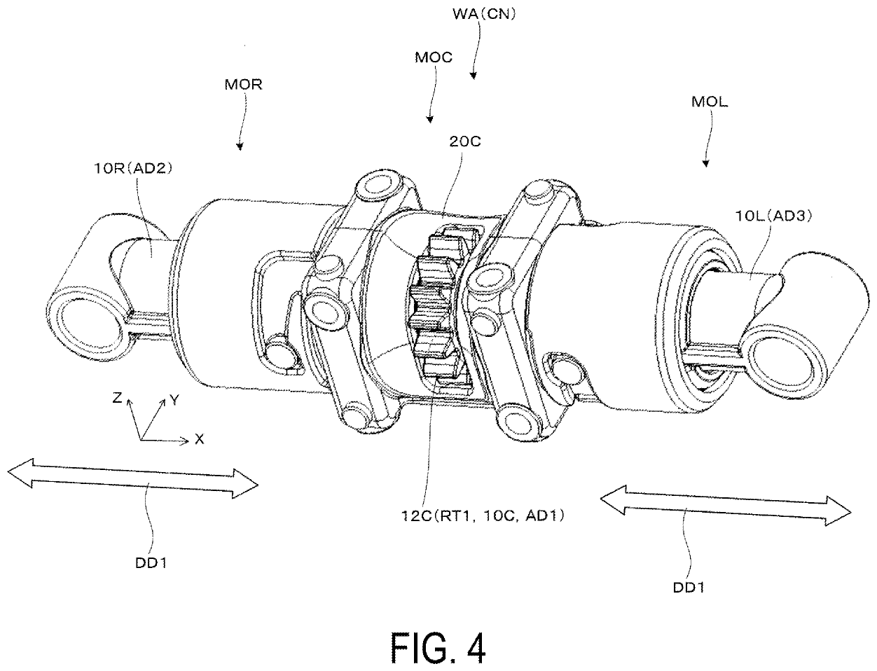

In particular, in the present embodiment, the eye distance adjustment system WA that functions as the coupling member CN advances and retreats in the left and right X direction (the direction along the direction from the first display unit 100a toward the second display unit 100b, or the direction in which the first display unit 100a and the second display unit 100b are aligned), thereby enabling eye width adjustment. Here, as described above, the X direction is referred to as the first direction, and is indicated by the arrow DD1 in FIG. 4, for example.

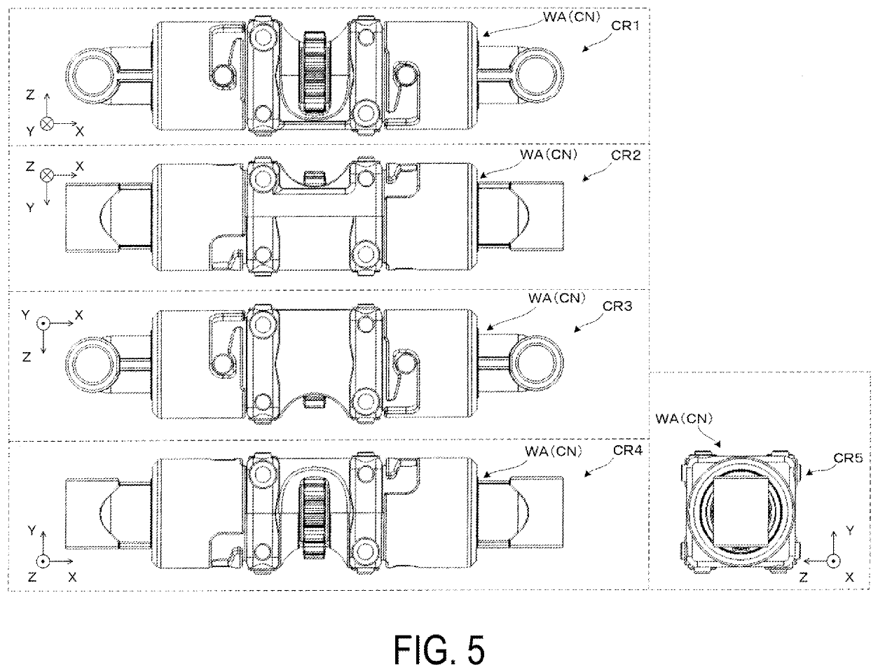

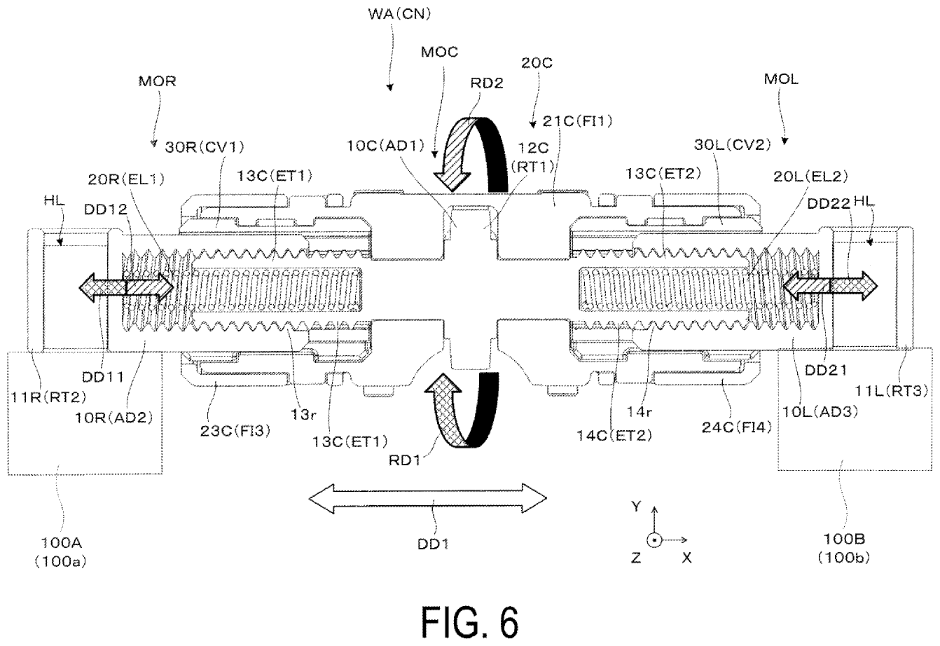

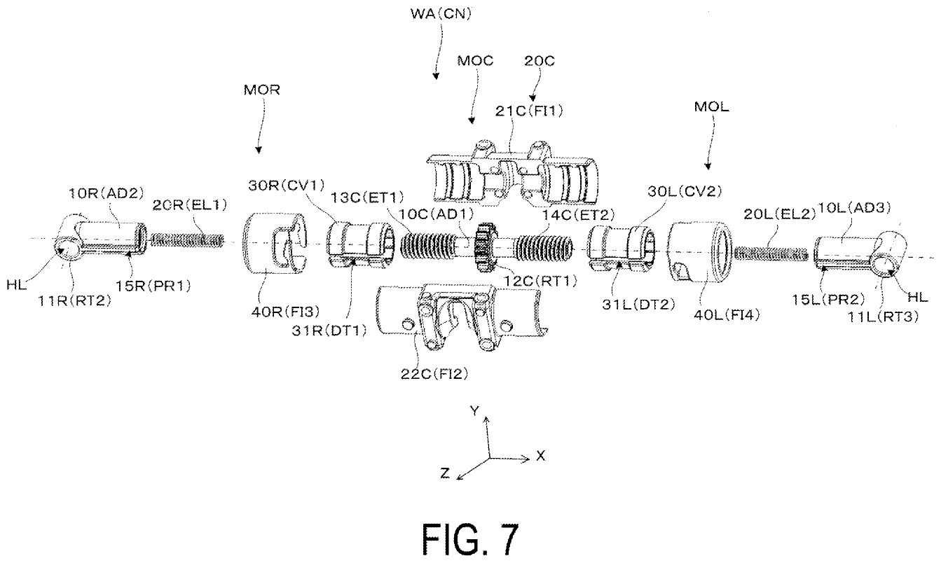

The structure, operations, and the like of the eye distance adjustment system WA according to the present embodiment will be described in detail below with reference to FIG. 4 and the like. FIG. 4 is a perspective view illustrating the external structure of the eye distance adjustment system WA. In FIG. 5, the states CR1 to CR5 are a bottom view, a rear view, a plan view, a front view, and a side view of the eye distance adjustment system WA, respectively. FIG. 6 is a front cross-sectional view of the eye distance adjustment system WA. FIG. 7 is an exploded perspective view of the eye distance adjustment system WA.

First, as illustrated in FIGS. 4 and 5, the eye distance adjustment system WA includes a central portion MOC that is fixed in the center, a right-side portion MOR that advances and retreats in the right-side portion, and a left-side portion MOL. Causing a worm wheel 12C (first rotating portion RT1), which is a rotating portion provided in the central portion MOC, to rotate with the first direction (X direction) as the axial direction of the rotation axis causes a movable unit 10R that is the movable site in the right-side portion MOR and a movable unit 10L that is the movable site in the left-side portion MOL to advance and retreat (expand and contract) along the first direction (X direction), as indicated by the arrow DD1.

To enable the operation as described above, of the eye distance adjustment system WA, the central portion MOC includes a base shaft member 10C and a fixing member 20C, as illustrated in FIGS. 6 and 7.

The right-side portion MOR includes, in addition to the movable unit 10R, a spring 20R and a bushing 30R. The left-side portion MOL includes, in addition to the movable unit 10L, a spring 20L and a bushing 30L.

Of the central portion MOC, the base shaft member 10C includes the worm wheel 12C, a right-side threaded portion 13C, and a left-side threaded portion 14C. The worm wheel 12C is the first rotating portion RT1 having the first direction that is the left and right direction indicated by the arrow DD1 as the axial direction of the rotation axis. In contrast, the right-side threaded portion 13C is a first extending portion ET1 extending to one side in the first direction, and the left-side threaded portion 14C is a second extending portion ET2 extending to the other side in the first direction. With the rotation of the worm wheel 12C located in the center in the first direction, the right-side threaded portion 13C extending to the right in the first direction and the left-side threaded portion 14C extending to the left in the first direction are rotated. This causes the movable unit 10R of the right-side portion MOR and the movable unit 10L of the left-side portion MOL to advance or retreat, whereby expansion or contraction for adjustment by the eye-width adjustment device WA is performed. That is, the base shaft member 10C causes the movable unit 10R and the movable unit 10L to advance or retreat, and functions as a first adjustment member AD1 that adjusts the eye width. Note that in this case, the orientation of the screw thread of the right-side threaded portion 13C (first extending portion ET1) is opposite to the orientation of the screw thread of the left-side threaded portion 14C (second extending portion ET2). Thus, when the worm wheel 12C is rotated in one direction, both the movable unit 10R and the movable unit 10L extend to expand outward; and when the worm wheel 12C is rotated in the reverse direction, both the movable unit 10R and the movable unit 10L contract inward. That is, as the movable unit 10R and the movable unit 10L expand and contract in the first direction (X direction), the eye distance adjustment system WA functions as a mechanism for adjusting the eye width.

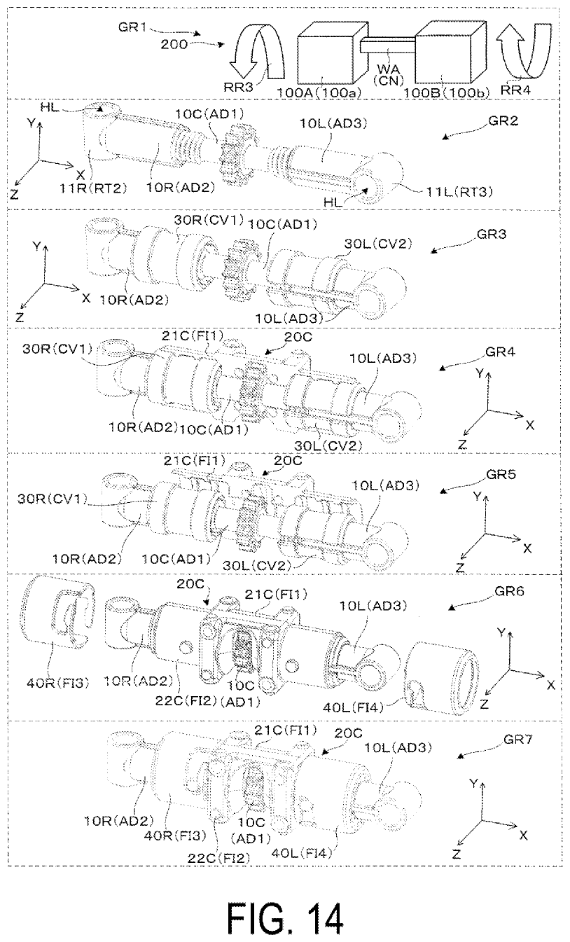

The fixing member 20C includes a near-side member 21C that is a first fixing member FI1, an outer surface-side member 22C that is a second fixing member FI2, a right attachment member 23C that is a third fixing member FI3, and a left attachment member 24C that is a fourth fixing member FI4. The near-side member 21C and the outer surface-side member 22C constitutes a pair disposed side by side in the front and rear direction that is the Z direction. For the right-side portion MOR and the left-side portion MOL assembled to the base shaft member 10C, the near-side member 21C and the outer surface-side member 22C maintain the movable unit 10R and the movable unit 10L that are inside in an advanceable and retreatable state, and fix the other components from the outside. The right attachment member 23C and the left attachment member 24C are assembled to and fix the near-side member 21C and the outer surface-side member 22C, between which components were sandwiched at the time of the assembly described above, further from the outside. Note that details of the assembly by the components of the fixing member 20C will be described later with reference to FIG. 14.

Of the right-side portion MOR, the movable unit 10R is a second adjustment member AD2 that contributes to eye width adjustment by moving in the first direction. The movable unit 10R includes a female thread-shaped portion 13r corresponding to the right-side threaded portion 13C (first extending portion ET1) that is a male thread, and is fitted to the right-side threaded portion 13C. For example, as illustrated in FIG. 6, when the worm wheel 12C (first rotating portion RT1) is rotated in a first rotational direction indicated by the arrow RD1, the movable unit 10R is moved in the direction (−X direction) of the arrow DD11 indicating one side in the first direction; when the worm wheel 12C is rotated in a second rotational direction indicated by the arrow RD2, which is the direction opposite to the first rotational direction, the movable unit 10R is moved in the direction (+X direction) of the arrow DD12 indicating the other side in the first direction. Note that in the drawings, the correspondence between the arrows RD1 and RD2 and the arrows DD11 and DD12 is indicated by hatching patterns.

In addition, as illustrated in FIG. 7, for example, the movable unit 10R is provided with a protruding portion 15R that is a first protrusion PR1 extending along the first direction. In the protruding portion 15R (first protrusion PR1), the movable unit 10R translates in the first direction indicated by the arrow DD1 (DD11 and DD12) as described above while rotation is suppressed by a slit 31R provided as a first groove portion DT1 in a bushing 30R to be described later.

Furthermore, the movable unit 10R includes an attachment portion 11R for attaching and fixing the first display unit 100a on the tip side that is farthest from the base shaft member 10C in the first direction. The attachment portion 11R includes a through hole HL extending in a direction perpendicular to the first direction. By inserting the protruding portion RTa of the first display unit 100a into the through hole HL, the first display unit 100a can be attached in a state of being axially rotatable in the first direction at the time of assembly. In other words, the movable unit 10R (second adjustment member AD2) has a second direction intersecting the first direction as the axial direction of the rotation axis (in the above example, the direction perpendicular to the first direction), and includes an attachment portion 11R as a second rotating section RT2 that causes the first display unit 100a to rotate. In addition, in the example illustrated in FIG. 6 and the like, the attachment portion 11R (second rotating portion RT2) is provided between the first display unit 100a and the base shaft member 10C (first adjustment member AD1) in the first direction. At this time, the first display unit 100a rotates with the second direction intersecting (orthogonal to) the first direction as the axial direction of the rotation axis. That is, the attachment portion 11R functions as the second rotating portion RT2 that causes the first display unit 100a to rotate.

As illustrated in the drawings, the spring 20R is a first elastic member EL1 that is covered by the right-side threaded portion 13C (first extending portion ET1) and the movable unit 10R (second adjustment member AD2), and that has the action of pressing against the right-side threaded portion 13C and the movable unit 10R in the first direction indicated by the arrow DD1 by elasticity. To describe more specifically, the end on one side of the spring 20R (first elastic member EL1) is in contact with the base shaft member 10C (first adjustment member AD1) and exerts a force to press against the base shaft member 10C in the +X direction of the first direction. The end on the other side of the spring 20R (first elastic member EL1) is in contact with the movable unit 10R (second adjustment member AD2) and exerts a force to press against the movable unit 10R in the −X direction of the first direction. By the action of the spring 20R as described above, the occurrence of looseness (rattling) at the fitting site when the movable unit 10R is moved is avoided or suppressed.

The bushing 30R is a first cover member CV1 that covers the right-side threaded portion 13C (first extending portion ET1) and a portion of the movable unit 10R (second adjustment member AD2). As illustrated in FIG. 7 and as described above, the bushing 30R (first cover member CV1) includes the slit 31R extending in the first direction along the protruding portion 15R (first protrusion PR1) of the movable unit 10R as the first groove portion DT1.

The left-side portion MOL has a configuration similar to that of the right-side portion MOR in a laterally inverted state. That is, the movable unit 10L, the spring 20L, and the bushing 30L in the left-side portion MOL have a function similar to that of the movable unit 10R, the spring 20R, and the bushing 30R in the right-side portion MOR, respectively.

For example, the movable unit 10L is a third adjustment member AD3 that contributes to eye width adjustment by moving in the first direction. The movable unit 10L includes a female thread-shaped portion 14r corresponding to the left-side threaded portion 14C (second extending portion ET2) that is a male thread, and is fitted to the left-side threaded portion 14C. When the worm wheel 12C is rotated in the direction of the arrow RD1, the movable unit 10L is moved in the direction (+X direction) of the arrow DD22. When the worm wheel 12C is rotated in the direction of the arrow RD2, the movable unit 10L is moved in the direction (−X direction) of the arrow DD21. Note that in the drawings, the correspondence between the arrows RD1 and RD2 and the arrows DD22 and DD21 is indicated by hatching patterns.

In addition, the movable unit 10L is provided with a protruding portion 15L that is a second protrusion PR2 extending along the first direction. The movable unit 10L translates in the first direction indicated by the arrow DD1 (DD22 and DD21) as described above while rotation is suppressed by a slit 31L provided as a second groove portion DT2 in the bushing 30L to be described later.

Furthermore, the movable unit 10L includes, as a third rotating portion RT3, an attachment portion 11L for attaching and fixing the second display unit 100b on the tip side that is farthest from the base shaft member 10C in the first direction. That is, the attachment portion 11L includes a through hole HL. By inserting the protruding portion RTb of the second display unit 100b into the through hole HL, as the third rotating portion RT3, the second display unit 100b can be attached in a state of being axially rotatable in the first direction at the time of assembly. In the case of the example illustrated in FIG. 6 and the like, the second display unit 100b rotates with a third direction intersecting (orthogonal to) the first direction as the axial direction of the rotation axis. That is, the attachment portion 11L functions as the third rotating portion RT3 that causes the second display unit 100b to rotate.

In addition, the spring 20L is a first elastic member EL2 that is covered by the left-side threaded portion 14C (second extending portion ET2) and the movable unit 10L (third adjustment member AD3), and that has the action of pressing against the left-side threaded portion 14C and the movable unit 10L in the first direction. That is, the spring 20L is in contact with the base shaft member 10C (first adjustment member AD1) and presses against the base shaft member 10C in the −X direction, and is in contact with the movable unit 10L (third adjustment member AD3) and presses against the movable unit 10L in the +X direction.

The bushing 30L is a second cover member CV2 that covers the left-side threaded portion 14C and a portion of the movable unit 10L. As described above, the bushing 30L includes the slit 31L extending in the first direction along the protruding portion 15L (second protrusion PR2) of the movable unit 10L as the second groove portion DT2.

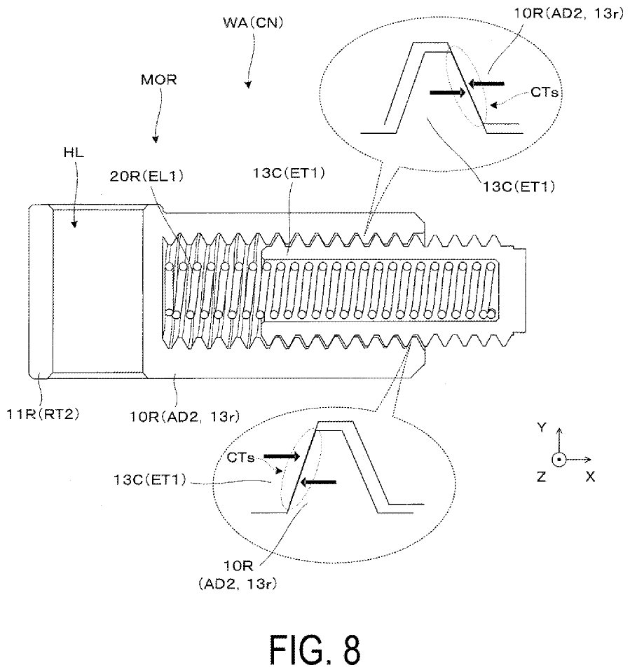

Here, for the avoidance or suppression of looseness (rattling) by the spring 20R and the spring 20L, as illustrated for example in FIG. 8 concerning the spring 20R (first elastic member EL1), the right-side threaded portion 13C (first extending portion ET1), and the movable unit 10R (second adjustment member AD2), the spring 20R is in a state of being shorter than the natural length, for example, and exerts a force in the direction of driving the right-side threaded portion 13C and the movable unit 10R away from each other. As indicated by being encircled with a dashed line in partially enlarged views, at the contact sites CTs between the right-side threaded portion 13C and the female thread-shaped portion 13r of the movable unit 10R, the right-side threaded portion 13C and the female thread-shaped portion 13r press against each other to create a place where there is no gap between them. Thus, when the movable unit 10R is moved with the rotation of the right-side threaded portion 13C, the occurrence of looseness (rattling) can be suppressed or avoided. Note that although illustration and description are omitted, the spring 20L (second elastic member EL2) acts similarly between the left-side threaded portion 14C (second extending portion ET2) and the female thread-shaped portion 14r of the movable unit 10L (third adjustment member AD3) as well.

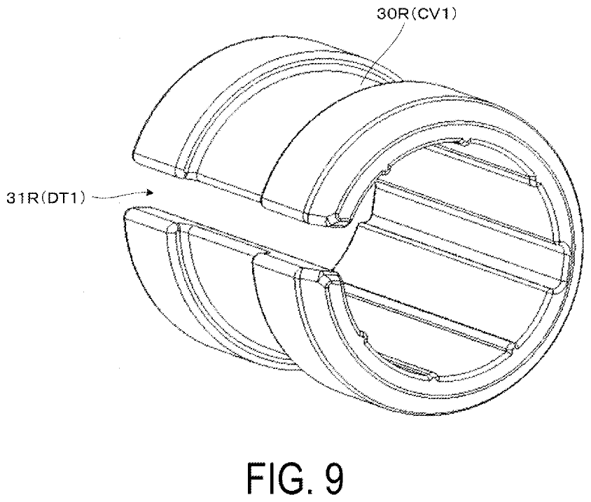

The restriction on the rotation of the movable unit 10R (second adjustment member AD2) by the bushing 30R (first cover member CV1) will be described below with reference to FIGS. 9, 10, and 11.

Note that the restriction on the rotation of the movable unit 10L (third adjustment member AD3) by the bushing 30L (second cover member CV2) is similar to that by the bushing 30R, and thus illustration and description are omitted.

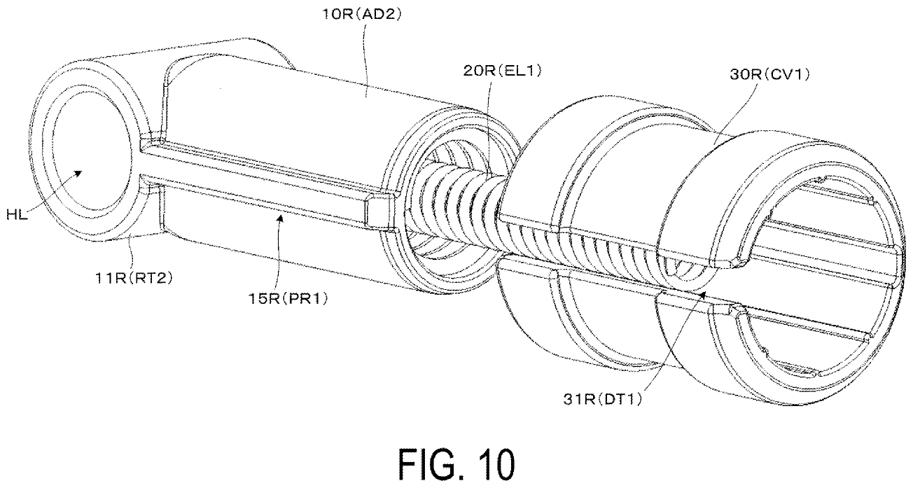

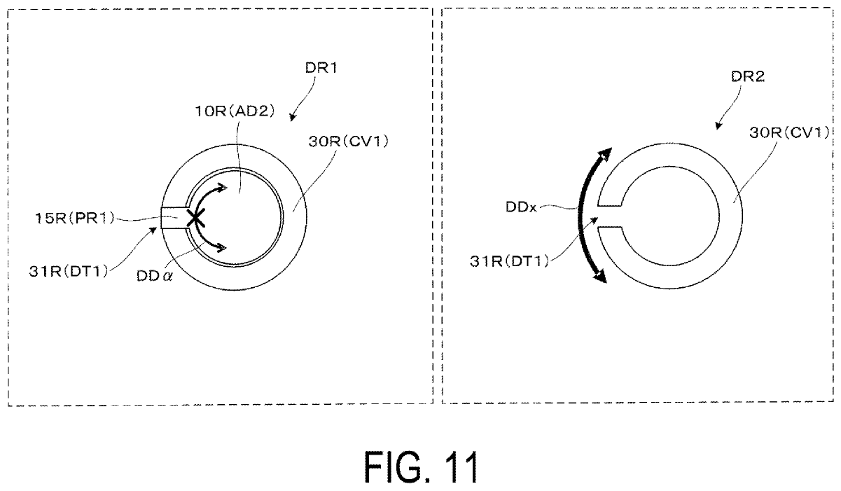

In the bushing 30R, as illustrated in FIG. 9 and as described above, the slit 31R extending in the first direction is provided and formed as the first groove portion DT1 in a cylindrical member extending in the first direction. Then, as illustrated in FIG. 10 and as described above, the bushing 30R is attached such that the slit 31R (first groove portion DT1) follows the protruding portion 15R (first protrusion PR1) of the movable unit 10R. This causes the protruding portion 15R of the movable unit 10R to be sandwiched in the slit 31R of the bushing 30R, as illustrated as the state DR1 in FIG. 11, for example. Here, as illustrated as the state DR2 in FIG. 11, the bushing 30R having a cylindrical shape is provided with the slit 31R, and thus the bushing 30R has flexibility (slightly moves) as indicated by the arrow DDx. While acting like a spring, as it were, the bushing 30R sandwiches the protruding portion 15R of the movable unit 10R to restrict the movable unit 10R from being moved in the rotational direction as indicated by the arrow DDα in the state DR1. That is, when the movable unit 10R is moved in the large direction, looseness (rattling) caused by axial rotation with the first direction as the axial direction is suppressed or avoided.

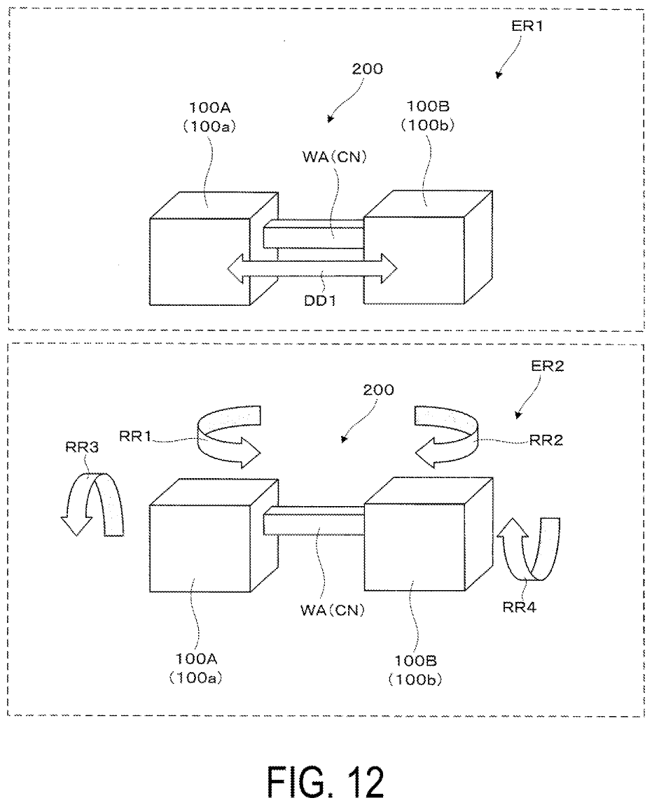

With the configuration described above, the eye distance adjustment system WA can expand and contract in the first direction (X direction), and at the time of such expansion or contraction, that is, when the movable unit 10R of the right-side portion MOR and the movable unit 10L of the left-side portion MOL advance or retreat in the first direction, the operation can be performed while maintaining a state in which looseness (rattling) is sufficiently suppressed or avoided. Therefore, for example, as conceptually illustrated as the state ER1 in FIG. 12, the head-mounted display device 200 as a finished product after the components have been assembled represents a mode in which the eye width can be adjusted by the eye distance adjustment system WA while maintaining the image display position with high accuracy. On the other hand, at the time of assembly of the head-mounted display device 200, that is, when attaching the components, as conceptually illustrated as the state ER2 in FIG. 12, the posture adjustment of the optical system by rotation mainly for convergence adjustment as indicated by the arrows RR1 and RR2, as well as the posture adjustment of the optical system by rotation mainly for image height/position adjustment as indicated by the arrows RR3 and RR4 are required. Note that the components are fixed such that the movements indicated by the arrows RR1 to RR4 do not occur after the assembly.

The eye distance adjustment system WA according to the present embodiment is capable of accommodating such posture adjustment at the time of assembly.

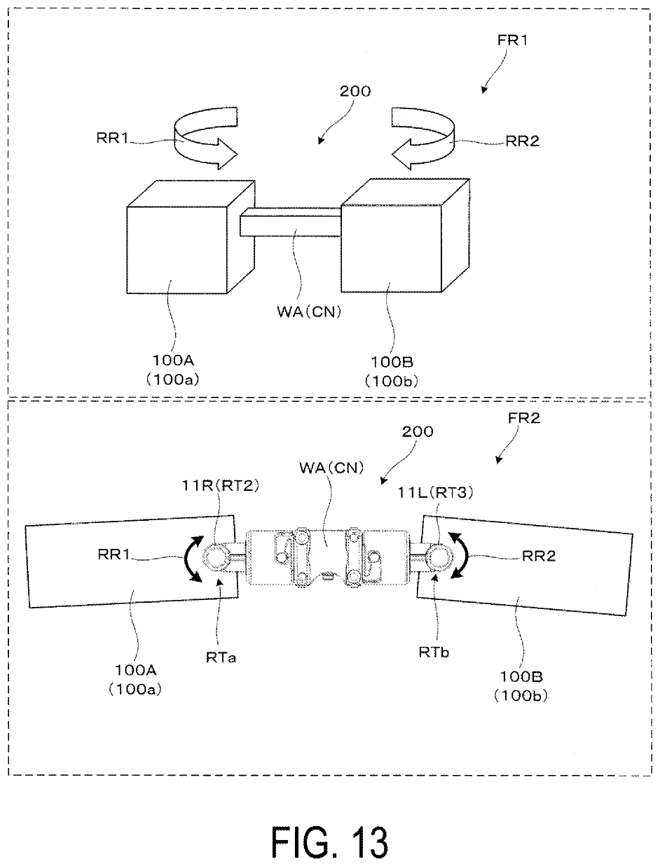

The posture adjustment of the optical system by rotation indicated by the arrows RR1 and RR2 will be described below with reference to FIG. 13. For the rotational movement indicated by the arrows RR1 and RR2 that is conceptually illustrated as the state FR1 in FIG. 13, as illustrated as the state FR2 and as described above, the protruding portion RTa of the first display unit 100a can be rotatably attached to the attachment portion 11R (second rotating portion RT2), and the protruding portion RTb of the second display unit 100b can be rotatably attached to the attachment portion 11L (third rotating portion RT3). Thus, desired posture adjustment is enabled.

The posture adjustment of the optical system by rotation indicated by the arrows RR3 and RR4 will be described below with reference to FIG. 14. Note that for rotations such as those of the arrows RR3 and RR4 that are conceptually illustrated as the state GR1 in FIG. 14, for the adjustment amount in posture adjustment, that is, for the range of rotation angles for adjustment, the required extent is typically approximately several degrees at most. The angular difference between the left and right optical systems is also assumed to be approximately the same. From the viewpoint of visibility, FIG. 14 illustrates the movable unit 10R of the right-side portion MOR and the movable unit 10L of the left-side portion MOL in a state of being moved by approximately 90 degrees relative to each other.

First, as illustrated in the state GR2 in FIG. 14, when the movable unit 10R and the movable unit 10L are screwed to the base shaft member 10C for assembly, the orientation of the through hole HL in the in-plane direction perpendicular to the first direction changes, in the attachment portion 11R and the attachment portion 11L, with the rotation with the first direction as the axial direction. At this time, the movable unit 10R is positioned at a position at which the posture adjustment of the optical system by the rotation indicated by the arrow RR3 is as desired and the movable unit 10R is sufficiently screwed, and the movable unit 10L is positioned at a position at which the posture adjustment of the optical system by the rotation indicated by the arrow RR4 is as desired and the movable unit 10L is sufficiently screwed. Thereafter, as illustrated in the state GR3, the bushing 30R (first cover member CV1) and the bushing 30L (second cover member CV2) are attached to restrict the axial rotational movement of the movable unit 10R and the movable unit 10L. Furthermore, as illustrated in the state GR4, the state GR5, and the state GR6, the bushing 30R and the bushing 30L are fixed by the near-side member 21C (first fixing member FI1) and the outer surface-side member 22C (second fixing member FI2) that constitute the fixing member 20C. Note that for the fixing method, fixing by bonding is assumed, for example. Furthermore, as illustrated in the state GR6 and the state GR7, the right attachment member 23C (third fixing member FI3) and the left attachment member 24C (fourth fixing member FI4) are attached (e.g., fitted) to the near-side member 21C and the outer surface-side member 22C, to which the bushing 30R and the bushing 30L have been bonded and fixed, from outside of the near-side member 21C and the outer surface-side member 22C. In this way, the eye distance adjustment system WA is manufactured that causes the movable unit 10R and the movable unit 10L to advance or retreat with the rotation of the worm wheel 12C (first rotating portion R1) while fixing the components.

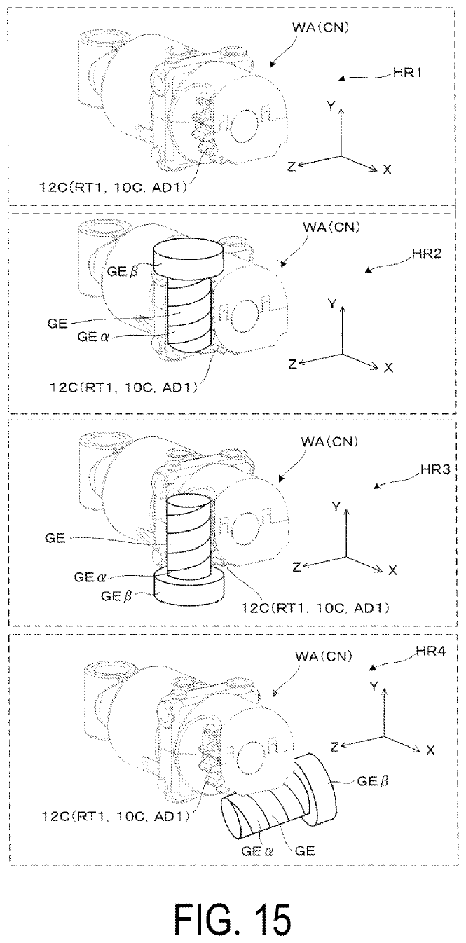

The mechanism for eye width adjustment after the assembly of the eye distance adjustment system WA and after the assembly of the components of the head-mounted display device 200 will be described below with reference to FIG. 15.

FIG. 15 is a conceptual cross-sectional perspective view illustrating an example of the eye distance adjustment system WA as a mechanism for eye width adjustment. The state HR1 illustrates a state in which a cross-section parallel to the Y-Z plane is cut out at a site nearest to the worm wheel 12C (first rotating portion RT1). Here, several examples of attachment modes of a worm gear GE for causing the worm wheel 12C to rotate will be illustrated. The worm gear GE is threaded in a shape corresponding to the worm wheel 12C. The worm gear GE functions as an adjustment knob for the user US to adjust the rotation (see FIG. 1). For example, as illustrated in the state HR2, a disposition can be employed in which the threaded portion GEα of the worm gear GE extends in the Y direction and the screw head GEβ is on the +Y side. In addition, for example, it is also conceivable to employ a disposition in which the threaded portion GEα extends in the Y direction and the screw head GEβ is on the −Y side as illustrated in the state HR3, and a disposition in which the threaded portion GEα extends in the Z direction and the screw head GEβ is on the +Z side as illustrated in the state HR4.

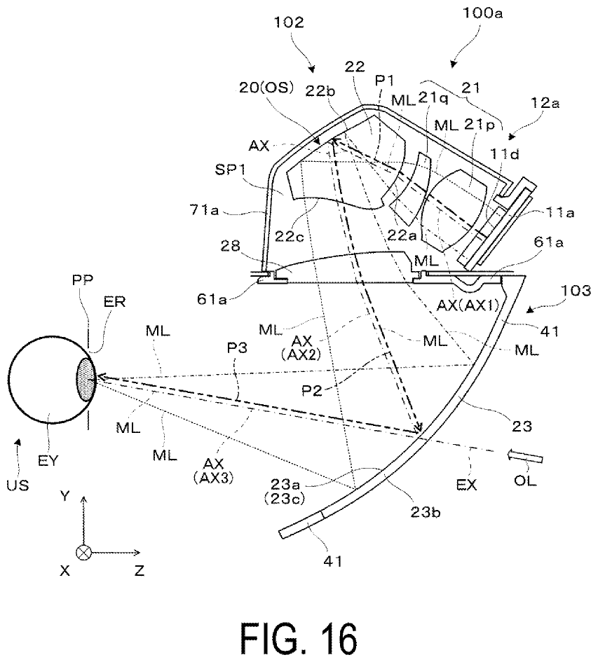

The optical system inside the head-mounted display device 200 will be described below with reference to a conceptual side cross-sectional view illustrated as FIG. 16.

In the example illustrated in FIG. 16, the first display unit 100a includes a first display element 11a, which is an image light-emitting portion that emits image light ML, and an imaging optical system 20 including an optical member on which the image light ML is incident, a reflection portion that reflects the image light ML from the optical member toward the position of a pupil (pupil position PP), and the like. The imaging optical system 20 is also referred to as the light guide optical device. The imaging optical system 20 includes a projection lens 21, a prism mirror 22, a plate-shaped optical element 28, and a see-through mirror 23. Of the imaging optical system 20, the projection lens 21, the prism mirror 22, and the plate-shaped optical element 28 correspond to the first optical system 12a illustrated in FIG. 3 and the like, and the see-through mirror 23 corresponds to the first combiner 103a. The first display element 11a, the projection lens 21, and the prism mirror 22 are fixed to the first frame 61a in a state of being mutually aligned by a frame body (not illustrated). The first display element 11a, the projection lens 21, and the prism mirror 22 are housed in a space SP1 sandwiched between the first cover member 71a and the first frame 61a. The plate-shaped optical element 28 is disposed to be fitted into a step formed at an optical opening of the first frame 61a. The periphery of the optical opening is held in an airtight state.

As described above, the first display element 11a is a self-light emission type display device including a light-emitting unit. The first display element 11a is, for example, an organic electroluminescence (EL) display, and forms a color still image or moving image on a two-dimensional display surface 11d. The first display element 11a is disposed along an x-y plane that is inclined by being slightly rotated about the X axis relative to the X-Y plane. The first display element 11a is driven by a control device provided in a printed wired board and performs display operations. The first display element 11a is not limited to an organic EL display, and can be replaced with a display device that uses a micro light-emitting diode (LED) display, inorganic EL, an organic LED, a laser array, a quantum dot light emission element, or the like. The first display element 11a is not limited to a self-light emission type image light generation device. The first display element 11a may include a liquid crystal display (LCD) and another light modulation element, and may form an image by illuminating the light modulation element with a light source such as a backlight. For the first display element 11a, a liquid crystal on silicon (LCOS; LCoS is a trade name), a digital micro-mirror device, or the like can be used instead of an LCD.

The projection lens 21 causes the image light ML emitted from the first display element 11a to pass therethrough and then to be incident on the prism mirror 22. The projection lens 21 focuses the image light ML emitted from the first display element 11a into a state close to a parallel luminous flux. The projection lens 21 includes a first lens 21p and a second lens 21q. The prism mirror 22 has an inner reflection surface 22b, and causes the image light ML emitted from the projection lens 21 to be incident on the inside, to be totally reflected by the inner reflection surface 22b, and to be emitted from a light emission surface 22c to the outside. At this time, the prism mirror 22 emits the image light ML incident from the front such that the image light ML is folded back in a direction inclined relative to the reversed direction of the incident direction (the direction of the light source as seen from the prism mirror 22). The plate-shaped optical element 28 causes the image light ML from the prism mirror 22 to pass therethrough while refracting the same. The see-through mirror 23 reflects the image light ML emitted from the prism mirror 22 toward the pupil position PP. The pupil position PP is a position at which the image light ML from the respective points on the display surface 11d is incident in a predetermined divergent state or a parallel state from angular directions corresponding to the positions of the respective points on the display surface 11d to overlap each other.

The see-through mirror 23 is a curved plate-shaped optical member that functions as a concave surface mirror, and reflects the image light ML incident from the prism mirror 22 via the plate-shaped optical element 28 toward the pupil position PP. That is, the see-through mirror 23 is a reflection portion that reflects the image light ML toward the pupil position PP. The see-through mirror 23 covers the pupil position PP at which the eye EY or the pupil is disposed, has a concave shape toward the pupil position PP, and has a convex shape toward the outside. The see-through mirror 23 is a mirror plate having a structure in which a mirror film 23c is formed on a front surface or a back surface of a plate-shaped body 23b. The reflection surface 23a of the see-through mirror 23 has transmissive properties. The outside light OL that has passed through the see-through mirror 23 and a support plate 41 therearound is also incident on the pupil position PP. That is, the user US wearing the head-mounted display device 200 can observe a virtual image by the image light ML superimposed on the outside image.

In the above description, the optical surface constituting the projection lens 21, the prism mirror 22, the plate-shaped optical element 28, and the see-through mirror 23 includes a free-curved surface. At least a portion of the optical surface can be replaced with a non-spherical surface or a spherical surface.

The imaging optical system 20 is an off-axis optical system OS due to the see-through mirror 23 being a concave mirror and the like. In the case of the present embodiment, the projection lens 21, the prism mirror 22, the plate-shaped optical element 28, and the see-through mirror 23 are disposed to be non-axisymmetric and have a non-axisymmetric optical surface. In this imaging optical system 20, that is, the off-axis optical system OS, an optical axis AX is bent such that the optical axis AX extends along an off-axis surface (a surface parallel to the Y-Z plane) corresponding to the paper surface. In this imaging optical system 20, the optical axis AX is bent in the off-axis surface parallel to the Y-Z plane, and thus the optical elements 21, 22, and 23 are arranged along the off-axis surface. The imaging optical system 20 includes optical axis portions AX1, AX2, and AX3 that are disposed along the off-axis surface (the surface parallel to the Y-Z plane), which is a reference surface extending in the longitudinal direction, and that are inclined relative to each other before and after the reflection surface. The optical axis AX as a whole extends along an optical path of the main beams emitted from the center of the display element 11a and passes through the center of the eye ring ER or the pupil corresponding to the eye point. When seen in a cross section parallel to the Y-Z plane, with the plurality of optical axis portions AX1, AX2, and AX3, the optical axis AX is disposed in a Z shape. That is, in the off-axis surface parallel to the Y-Z plane, an optical path P1 from the projection lens 21 to the inner reflection surface 22b, an optical path P2 from the inner reflection surface 22b to the see-through mirror 23, and an optical path P3 from the see-through mirror 23 to the pupil position PP are bent in two stages in a Z shape.

In the example described above illustrated in FIG. 16, the prism mirror 22, which is an optical member, is provided between the first display element 11a as the image light-emitting portion and the intermediate image of the image light ML in the optical path of the image light ML.

Note that in the examples described above, configuring the diameter of the eye ring as approximately 6 mm, for example, can be considered. Furthermore, in the case of a disposition such as that illustrated in the drawings (e.g., FIG. 3 and the like), it is assumed that approximately 6 mm can be secured as the adjustable width in the eye distance adjustment system WA. In this case, an eye width difference of up to approximately 12 mm in total can be accommodated.

As described above, the head-mounted display device 200 according to the present embodiment includes: the first adjustment member AD1 including the first rotating portion RT1 having the first direction as the axial direction and the first extending portion ET1 extending to one side in the first direction; the second adjustment member AD2 that is configured to be fitted to the first extending portion ET1, that is configured to be moved to the one side in the first direction when the first rotating portion RT1 is rotated in a first rotational direction, and that is configured to be moved to the other side in the first direction when the first rotating portion RT1 is rotated in a second rotational direction that is a direction opposite to the first rotational direction; the first display unit 100a fixed by the second adjustment member AD2; and the first elastic member EL1 of which one side is in contact with the first adjustment member AD1, of which the other side is in contact with the second adjustment member AD2, and that is covered by the first extending portion ET1 and the second adjustment member AD2. In the head-mounted display device 200 described above, the elasticity of the first elastic member EL1 covered by the first extending portion ET1 of the first adjustment member AD1 and the second adjustment member AD2 is utilized to prevent looseness (rattling) between the first adjustment member AD1 and the second adjustment member AD2 from occurring. Thus, even in a configuration in which the second adjustment member AD2 is movable and position adjustment in accordance with the eye width of the user US is enabled, image deterioration due to adjustment can be avoided or suppressed.

### Modified Examples and Others

The present disclosure has been described above based on embodiments. However, the present disclosure is not limited to the above-described embodiments. The present disclosure may be carried out in various modes without departing from the gist of the present disclosure. For example, the following modifications may be carried out.

The imaging optical system 20 incorporated into the first display unit 100a is not limited to those illustrated in the drawings, and may be of various configurations. Specifically, the imaging optical system 20 described above is an off-axis optical system OS having asymmetry in the Y direction or the longitudinal direction, but can also be an off-axis optical system having asymmetry in the X direction or the lateral direction. For the optical elements constituting the imaging optical system 20, those illustrated in FIG. 16 are mere examples, and modifications can be made such as changing the number of lenses, adding a mirror, and adding a light guide member.

A light control device that controls light by limiting transmitted light of the combiners 103a and 103b may be attached on the outer side of the combiners 103a and 103b. The light control device adjusts the transmittance electrically, for example. For the light control device, a mirror liquid crystal, an electronic shade, and the like can be used. The light control device may be one that adjusts the transmittance in accordance with the brightness of outside light.

The combiners 103a and 103b can also be replaced with a mirror having light-blocking properties. In this case, the optical system will be of a non-see-through type that does not presuppose direct observation of the external image.

The structure of the attachment portions 11R and 11L is not limited to that provided with a through hole, and can be replaced by various mechanisms that have a degree of freedom required for posture adjustment, such as that having a ball-joint shape, for example.

The above description presupposes that the head-mounted display device 200 is worn on the head to be used. However, the head-mounted display device 200 described above can also be used as a handheld display to be looked into like binoculars. That is, in the present disclosure, the head-mounted display also encompasses a hand-held display.

The first frame 61a, the second frame 61b, and the eye distance adjustment system WA are not limited to those formed of a metal material, and may be those formed of a fiber-reinforced plastic (FRP).

In the above description, light is guided in the longitudinal direction or the Y direction. However, a configuration can also be employed in which light is guided in the lateral direction or the X direction.

A head-mounted display device according to a specific mode includes: a first adjustment member including a first rotating portion having a first direction as an axial direction and a first extending portion extending to one side in the first direction; a second adjustment member that is configured to be fitted to the first extending portion, that is configured to be moved to the one side in the first direction when the first rotating portion is rotated in a first rotational direction, and that is configured to be moved to the other side in the first direction when the first rotating portion is rotated in a second rotational direction that is a direction opposite to the first rotational direction; a first display unit fixed by the second adjustment member; and a first elastic member of which one side is in contact with the first adjustment member, of which the other side is in contact with the second adjustment member, and that is covered by the first extending portion and the second adjustment member.

In the head-mounted display device described above, the elasticity of the first elastic member covered by the first extending portion of the first adjustment member and the second adjustment member is utilized to prevent looseness (rattling) between the first adjustment member and the second adjustment member from occurring. Thus, even in a configuration in which the second adjustment member is movable and position adjustment in accordance with the eye width of the user is enabled, image deterioration due to adjustment can be avoided or suppressed.

In a specific aspect, the second adjustment member includes a second rotating portion that has a second direction intersecting the first direction as an axial direction and that is configured to cause the first display unit to rotate and the second rotating portion is provided between the first display unit and the first adjustment member in the first direction. In this case, the posture of the first display unit can be adjusted by the second rotation portion provided between the first display unit and the first adjustment member.

In a specific aspect, the first display unit includes an image light-emitting portion configured to emit image light, an optical member on which the image light is incident, and a reflection portion configured to reflect the image light from the optical member toward a position of a pupil. In this case, the image light emitted from the image light-emitting portion can be guided toward the pupil of the user by the optical member and the reflection portion.

In a specific aspect, the optical member is provided between the image light-emitting portion and an intermediate image of the image light in an optical path of the image light. In this case, for example, the image light-emitting portion can be provided at a position away from the front of the user's eye with the optical path length secured. Thus, a see-through configuration can be realized in front of the eye.

A specific aspect further includes: a third adjustment member that is configured to be moved to the other side in the first direction when the first rotating portion is rotated in the first rotational direction and that is configured to be moved to the one side in the first direction when the first rotating portion is rotated in the second rotational direction; and a second elastic member of which one side is in contact with the first adjustment member and of which the other side is in contact with the third adjustment member; wherein the first adjustment member includes a second extending portion extending to the other side in the first direction, the third adjustment member is fitted to the second extending portion, and the second elastic member is covered by the second extending portion and the third adjustment member. In this case, the eye width can be adjusted by that which is moved to one side and that which is moved to the other side in the first direction, for example.

A specific aspect further includes: a first cover member covering the first extending portion and a portion of the second adjustment member; wherein the second adjustment member includes a first protrusion extending along the first direction and the first cover member includes a first groove portion along the first protrusion. In this case, when the second adjustment member is moved, the occurrence of unintended rotation can be suppressed or avoided by the first protrusion of the second adjustment member and the first groove portion of the first cover member.

A specific aspect further includes: a second cover member covering the second extending portion and a portion of the third adjustment member; wherein the third adjustment member includes a second protrusion extending along the first direction and the second cover member includes a second groove portion along the second protrusion. In this case, when the third adjustment member is moved, the occurrence of unintended rotation can be suppressed or avoided by the second protrusion of the third adjustment member and the second groove portion of the second cover member.

A specific aspect further includes a fixing member covering the first cover member, the second cover member, and a portion of the first rotating portion. In this case, the first cover member and the second cover member can be fixed by the fixing member while being covered together with a portion of the first rotating portion.

A specific aspect further includes: a second display unit fixed by the third adjustment member; wherein the third adjustment member includes a third rotating portion that has a third direction intersecting the first direction as an axial direction and that is configured to cause the second display unit to rotate. In this case, the posture of the second display unit can be adjusted by the third rotating portion.

An eye distance adjustment system according to a specific mode includes: a first adjustment member including a first rotating portion having a first direction as an axial direction and a first extending portion extending to one side in the first direction; a second adjustment member that is configured to fix a display unit, that is configured to be fitted to the first extending portion, that is configured to be moved to the one side in the first direction when the first rotating portion is rotated in a first rotational direction, and that is configured to be moved to the other side in the first direction when the first rotating portion is rotated in a second rotational direction that is a direction opposite to the first rotational direction; and a first elastic member of which one side is in contact with the first adjustment member, of which the other side is in contact with the second adjustment member, and that is covered by the first extending portion and the second adjustment member.

In the eye distance adjustment system described above, the elasticity of the first elastic member covered by the first extending portion of the first adjustment member and the second adjustment member is utilized to prevent looseness (rattling) between the first adjustment member and the second adjustment member from occurring. Thus, even in a configuration in which the second adjustment member is movable and position adjustment in accordance with the eye width of the user is enabled, image deterioration due to adjustment can be avoided or suppressed.

What is claimed is:

1. A head-mounted display device, comprising:
a first adjustment member including a first rotating portion having a first direction as an axial direction, and a first extending portion extending to one side in the first direction;
a second adjustment member configured to be fitted with the first extending portion, and configured to move to the one side in the first direction when the first rotating portion rotates in a first rotational direction, and to move to another side in the first direction when the first rotating portion rotates in a second rotational direction that is a direction opposite to the first rotational direction;
a first display unit fixed by the second adjustment member; and
a first elastic member having one side in contact with the first adjustment member and another side in contact with the second adjustment member, the first elastic member being covered with the first extending portion and the second adjustment member.

2. The head-mounted display device according to claim 1, wherein
the second adjustment member includes a second rotating portion configured to rotate the first display unit with a second direction intersecting the first direction as an axial direction, and
the second rotating portion is provided between the first display unit and the first adjustment member in the first direction.

3. The head-mounted display device according to claim 1, wherein
the first display unit includes
an image light-emitting portion configured to emit image light,
an optical member on which the image light is incident, and
a reflection portion configured to reflect the image light from the optical member toward a position of a pupil.

4. The head-mounted display device according to claim 3, wherein the optical member is provided between the image light-emitting portion and an intermediate image of the image light in an optical path of the image light.

5. The head-mounted display device according to claim 1, comprising:
a third adjustment member configured to move to the other side in the first direction when the first rotating portion rotates in the first rotational direction, and to move to the one side in the first direction when the first rotating portion rotates in the second rotational direction; and
a second elastic member having one side in contact with the first adjustment member and another side in contact with the third adjustment member, wherein
the first adjustment member includes a second extending portion extending to the other side in the first direction,
the third adjustment member is fitted with the second extending portion, and
the second elastic member is covered with the second extending portion and the third adjustment member.

6. The head-mounted display device according to claim 5, comprising
a first cover member configured to cover the first extending portion and a portion of the second adjustment member, wherein
the second adjustment member includes a first protrusion extending along the first direction, and
the first cover member includes a first groove portion along the first protrusion.

7. The head-mounted display device according to claim 6, comprising
a second cover member configured to cover the second extending portion and a portion of the third adjustment member, wherein
the third adjustment member includes a second protrusion extending along the first direction, and
the second cover member includes a second groove portion along the second protrusion.

8. The head-mounted display device according to claim 7, comprising
a fixing member configured to cover the first cover member, the second cover member, and a portion of the first rotating portion.

9. The head-mounted display device according to claim 6, comprising
a second display unit fixed by the third adjustment member, wherein
the third adjustment member includes a third rotating portion configured to rotate the second display unit with a third direction intersecting the first direction as an axial direction.

10. An eye distance adjustment system, comprising:
a first adjustment member including a first rotating portion having a first direction as an axial direction, and a first extending portion extending to one side in the first direction;
a second adjustment member configured to fix a display unit, and to be fitted with the first extending portion, the second adjustment member being configured to move to the one side in the first direction when the first rotating portion rotates in a first rotational direction, and to move to another side in the first direction when the first rotating portion rotates in a second rotational direction that is a direction opposite to the first rotational direction; and
a first elastic member having one side in contact with the first adjustment member and another side in contact with the second adjustment member, the first elastic member being covered by the first extending portion and the second adjustment member.
